(19) United States
(12) Patent Application Publication
(10) Pub. No.: US 2024/0108523 A1
(43) Pub. Date: Apr. 4, 2024

(54) MATTRESS TOPPER FOR WASTE CONTROL

(71) Applicant: PUREWICK CORPORATION, Covington, GA (US)

(72) Inventors: Jill W. Jones, Avondale Estates, GA (US); Christopher K. Brooks, Decatur, GA (US)

(21) Appl. No.: 18/264,004

(22) PCT Filed: Feb. 7, 2022
(86) PCT No.: PCT/US2022/015492

§ 371 Date: Aug. 2, 2023

Related U.S. Application Data
(60) Provisional application No. 63/146,946, filed on Feb. 8, 2021.

(51) Int. Cl. A61G 7/02

(52) U.S. Cl. CPC A61G 7/02

(57) ABSTRACT

Examples relate to devices, systems, and methods of using mattress pads to prevent soiling of beds and to organize equipment associated with collection of bodily waste. The devices, systems, and methods of disclosed herein include a mattress pad having a retention port thereon. The retention port includes one or more retainers disposed around an outer boundary of the retention port. The one or more retainers hold objects, such as tubing, relative to the retention port. The mattress pad includes one or more attachments sized and shaped to at least temporarily attach the mattress pad to a mattress or bed

### CROSS-REFERENCE TO RELATED APPLICATIONS

This application claims priority to U.S. Provisional Patent Application No. 63/146,946 filed on 8 Feb. 2021, the disclosure of which is incorporated herein, in its entirety, by this reference.

### BACKGROUND

An individual may have limited or impaired mobility such that bowel movements in a restroom are challenging or impossible. For example, the individual may have a condition, had a surgery, or a have disability that impairs mobility. Additionally, fluid or stool collection from the individual may be needed for monitoring purposes or clinical testing.

Beds and bedding for treating such individuals may become soiled during use. Such beds and bedding may be may be prone to discomfort if conventional urine and fecal collection devices are used. Thus, users and manufacturers of patient care beds continue to seek new and improved devices, systems, and methods to prevent beds from becoming soiled.

### SUMMARY

Embodiments disclosed herein are related to mattress toppers, systems, and methods of using mattress pads to collect waste from a patient. In an embodiment, a mattress pad for collecting waste is disclosed. The mattress pad includes a pad sized and shaped to cover at least a portion of a mattress. The mattress pad includes a retention port located in a region of the pad, the retention port including one or more retainers disposed around an outer boundary thereof, the one or more retainers being configured to hold one or more objects relative to the retention port. The mattress pad includes one or more attachments disposed on the pad, the one or more attachments being configured to at least temporarily attach the pad to the mattress.

In an embodiment, a bodily waste collection system is disclosed. The bodily waste collection system includes a mattress pad as disclosed above. The bodily waste collection system includes at least one fluid storage container configured to hold a fluid. The bodily waste collection system includes at least one of a bodily waste collection device or a fluid collection device retained relative to the mattress pad by the retention port and fluidly coupled to the at least one fluid storage container via at least one drainage tube. The bodily waste collection system includes a vacuum source fluidly coupled to one or more of the at least one of the fluid storage container or the at least one bodily waste collection device via the at least one drainage tube, the vacuum source configured to draw fluid into the at least one fluid storage container from the at least one of a bodily waste collection device or a fluid collection device via the at least one drainage tube.

In an embodiment, a method for utilizing a mattress pad is disclosed. The method includes using a mattress pad having a retention port located in a region thereof, positioning at least one drainage tube in the retention port. The method includes securing the at least one drainage tube in the retention port. The method includes connecting the at least one drainage tube to one or more of a fluid storage container, a vacuum source, a fluid collection device, or a bodily waste collection device.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is an isometric view of a mattress pad for collecting waste, according to an embodiment.

FIG. 2 is an isometric view of a mattress pad for collecting waste, according to an embodiment.

FIG. 3 is a schematic of system for collecting waste, according to an embodiment.

FIG. 4 is an isometric view of a fluid collection device, according to an embodiment.

FIG. 5 is a cross-sectional view of the fluid collection device of FIG. 4 along the plane A-A.

FIG. 6 is an isometric view of bodily waste collection device, according to an embodiment.

FIG. 7 is an isometric view of a system for collecting waste, according to an embodiment.

FIG. 8 is an isometric view of the system for collecting waste with a partially open cover, according to an embodiment.

FIG. 9 is a flow diagram of a method to collect bodily waste, according to an embodiment.

### DETAILED DESCRIPTION

Embodiments disclosed herein are related to devices, systems, and methods of using mattress toppers to prevent soiling of beds and to organize equipment associated with collection of bodily waste. The devices, systems, and methods disclosed herein include a mattress topper (e.g., pad) having a retention port thereon. The retention port includes one or more retainers disposed around an outer boundary of the retention port. The one or more retainers hold objects, such as tubing, relative to the retention port. The mattress pad includes one or more attachments sized and shaped to at least temporarily attach the mattress pad to a mattress or bed.

The devices, systems, and methods disclosed herein manage tubing for bodily waste and fluid collection devices for bedbound patients. Such management allows retention of bodily waste and fluid collection devices with respect to a selected position on the mattress pad (and patient), provides for patient comfort by preventing the patient from laying on drainage tubes of the bodily waste and fluid collection devices, prevents leaks and spills of bodily fluids from waste collection devices or tubing due to tubing or fluid collection devices being out of position (e.g., twisted or dislodged due to a pulled drainage tube), prevents soiling of the mattress and/or bedding underneath the mattress pad, and prevents unsanitary conditions on the patient due to spilled or leaking bodily fluid that is either not collected in or leaking from bodily waste and fluid collection devices that are out of position.

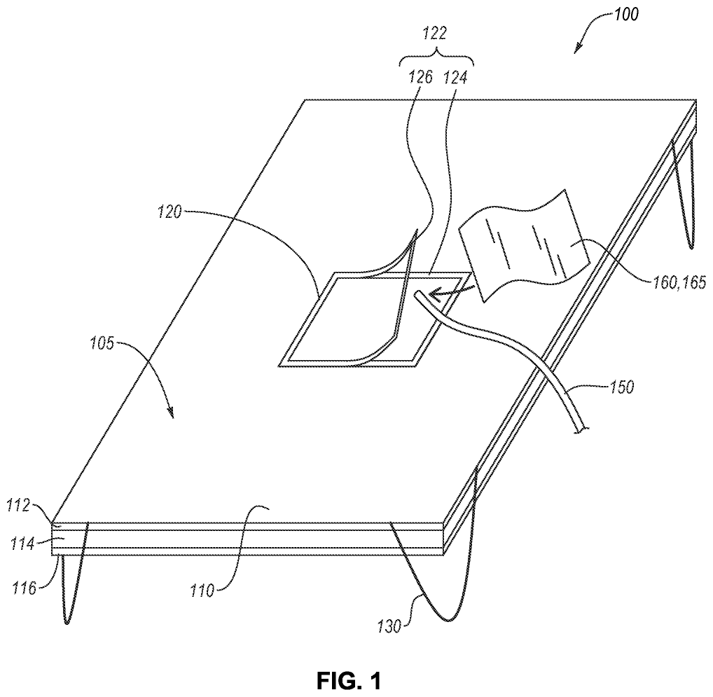

FIG. 1 is an isometric view of a mattress pad 100 for collecting waste, according to an embodiment. The mattress pad 100 includes a pad 110, a retention port 120 on the pad 110, and one or more attachments 130 disposed on the pad 110. The retention port 120 may be used to at least temporarily retain one or more objects relative to the pad 110, such as one or more drainage tubes 150 (e.g., conduits), fluid collection devices, waste collection devices, or the like. Accordingly, the retention port 120 may help organize and retain tubing and devices used on a patient on the mattress pad 100. The retention port 120 may also be used to position or retain fluid impermeable sheets or sanitary pads (e.g., chucks) in a central region of the mattress pad 100, such as where the pelvis of the patient may be positioned on the mattress pad 100 during use.

The pad 110 is sized and shaped to cover at least a portion of a mattress. For example, the pad 110 is dimensioned to fit over at least a portion the mattress, such as a hospital bed mattress. The pad 110 may be sized to fit over a twin size mattress, a full size mattress, or the like. The pad 110 includes a sheet of fabric 112, such as fabric having fibers made of one or more of cotton, polymer (e.g., polyester), satin, silk, linen, or combinations thereof (e.g., poly-cotton). The fabric 112 may be on an upper surface 105 of the pad 110, such as a patient facing side of the pad 110.

The pad 110 may include padding 114 disposed below the sheet of fabric 112. The padding 114 may include cotton fibers, wool fibers, spun plastic fibers (e.g., polyester), down, polymer foam, or the like. The padding 114 may be provided as a filler (e.g., pieces), as a solid body (e.g., sheet), or panels. The padding 114 may be at least 5 mm thick (when in an uncompressed state), such as 5 mm to 10 cm, 5 mm to 3 cm, 3 cm to 6 cm, 6 cm to 10 cm, less than 10 cm, less than 5 cm, or more than 10 cm.

The pad 110 may include one or more fluid impermeable sheets 116 or 160. The fluid impermeable sheets 116 or 160 may include a fabric, rubber, or polymer sheet that is impermeable to fluids, such as a plastic (e.g., polyethylene, polyester, vinyl, or the like) sheet. The fluid impermeable sheets 116 or 160 may extend along at least a portion or all of the lateral dimensions of the sheet of fabric 112. The fluid impermeable sheets 116 or 160 may extend across at least the retention port 120. The pad 110 may include the fluid impermeable sheet 116 disposed below the sheet of fabric 112, such as below, the padding 114, above the padding 114, or both. The fluid impermeable sheets 116 or 160 prevent or limits fluids from soiling the mattress disposed below the mattress pad 100. For example, urine from a patient on the mattress pad 100 may be collected in a urine collection device and any urine that leaks from the patient or device is prevented from reaching the mattress underneath the mattress pad 100.

The pad 110 may include the fluid impermeable sheet 160 disposed on or above the sheet of fabric 112. The fluid impermeable sheet 160 may be sized to fit within or on the area around the retention port 120. For example the fluid impermeable sheet 116 may be sized to fit within the retention port to prevent bodily fluids from penetrating beneath the retention port 120. In some examples, the fluid impermeable sheet 116 may be exposed in the retention port 120, such as when the retention port 120 does not include the sheet of fabric 112 therein (e.g., a gap in the sheet of fabric 112). The fluid impermeable sheet 160 may be coextensive with the one or both of sheet of fabric 112 or the padding 114. The fluid impermeable sheet 160 may include a comfort pad 165 or fabric on an uppermost surface thereof, such as a soft fabric to prevent bed sores. In such examples, the fluid impermeable sheet and comfort pad 165 affixed thereon may be replace periodically, after use, or after soiling.

In some examples, the one or two of the sheet of fabric 112, the padding 114, or the fluid impermeable sheet may be omitted. In such examples, the retention port 120 is disposed on the uppermost layer of the pad 110.

The retention port 120 is located in a central region of the pad 110 or another suitable region that may be offset from the center of the pad 110. For example, the retention port 120 may be disposed in a middle portion (e.g., central region) of the mattress pad 100 expected (e.g., suitable and intended) to hold a pelvic region of the patient thereon when in use. The retention port 120 includes a one or more retainers 122 disposed thereon, such as around (and at least partially defining) an outer boundary thereof.

The one or more retainers 122 hold one or more objects relative to the retention port 120. For example, the one or more retainers 122 may include one or more boundary strips. The boundary strips may include fabric bodies that have one or more fasteners thereon. The strips may include at least a first strip 124 and a second strip 126 disposed at or around the boundary of the retention port 120. The shape of the second strip 126 may at least partially correspond to the shape of the first strip 124, such as to be at least partially coextensive when attached to each other. The first strip(s) 124 may be disposed on the pad 110 and the second strip(s) 126 may be free floating. During use, the second strip 126 may be applied to the first strip 124 where the fasteners thereon engage and at least temporarily affix at least a portion of the second strip 126 to the first strip 124. In some examples, the first strip 124 may be at least partially formed from the pad 110, such as a portion of the sheet of fabric 112. In such examples, the fastener(s) (e.g., hooks or loops) may be applied directly on the sheet of fabric to at least partially define the retention port 120. Accordingly, the fasteners (and strips carrying the same) are selectively attachable and removable with respect to each other.

The second strip 126 may include an uppermost surface (e.g., patient facing surface) having a soft and/or smooth material thereon. For example, the uppermost surface of the second strip 126 may include the same fabric as the sheet of fabric 112, rubber, polymer, or another fabric to provide a soft and/or smooth interface with the patient. Accordingly, bedsores or discomfort can be eliminated while still securing medical tubing in the retention port 120.

One or more of the pad 110 or the retention port 120 includes one or more openings therein sized and shaped to accommodate a drainage tube 150 therethrough. For example, a drainage tube 150 for one or more medical devices may be positioned through the retention port 120 and/or the pad 110. In such examples, the drainage tube 150 may be anchored in the retention port 120 and disposed through the one or more openings to allow a portion of the drainage tube 150 to be disposed below pad 110, such as to hide or prevent tangles of the drainage tube. The drainage tube 150 may be attached to a medical device such as a urine collection device or a bodily waste (e.g., stool) collection device.

The drainage tube 150 may include medical tubing. For example, the drainage tube 150 may be constructed of one or more polymers such as silicone, latex, ethylene vinyl acetate (EVA), polytetrafluoroethylene (PTFE), silicone polyurethane, polyamide, polyurethane, polyethylene, other thermoplastics and block copolymers thereof, or any other suitable polymers for medical use.

The fasteners may be disposed on the first and second strips 124, 126 to affix the second strip(s) 126 to the first strip(s) 124. The first strip 124 may include a first fastener and the second strip 126 may include a second fastener corresponding to the first fastener. The first and second fasteners may include hook and loop fasteners, buttons and holes, snaps (e.g., sockets and studs), zippers, magnets, or the like. For example, the first strip(s) 124 may include hooks affixed to the pad 110 and the second strip(s) 126 may include loops affixed to a fabric body, and the second strip(s) 126 may be free floating for selective attachment to the first strip(s) 124.

The mattress pad 100 may include one or more attachments 130. The one or more attachments 130 are sized, shaped, and located on the pad 110 to at least temporarily attach the mattress pad 100 to a mattress (not shown). The one or more attachments 130 may be straps as shown in FIG. 1, clips, hook and loop fasteners, ties, or the like. The straps may be elastic straps sized and shaped to fit over the corners of a mattress to retain the mattress pad 100 thereon and to retain the position of the retention port 120 relative to the mattress below the mattress pad 100. The one or more attachments 130 may be spaced along an outer edge of the pad 110. For example, the one or more attachments 130 may include an attachment on one or more of the corners of the pad 110. In examples (not shown), the pad 110 may be shaped as a fitted sheet and the one or more attachments 130 may include elastic around an opening of the fitted sheet.

In some examples, the mattress pad 100 may be sized and shaped to cover only the central region of a mattress, such as where the pelvic region of a patient is expected to be placed. In such examples, the retention port 120 may make up a larger proportion of the mattress pad 100 than depicted in FIG. 1. In such examples, the attachments 130 may maintain the position of the mattress pad 100 with respect to the mattress underneath such as by attachment to the mattress, bedding, or rails of a hospital bed. Any of the mattress pads disclosed herein may have the size of a mattress or may be smaller than a mattress.

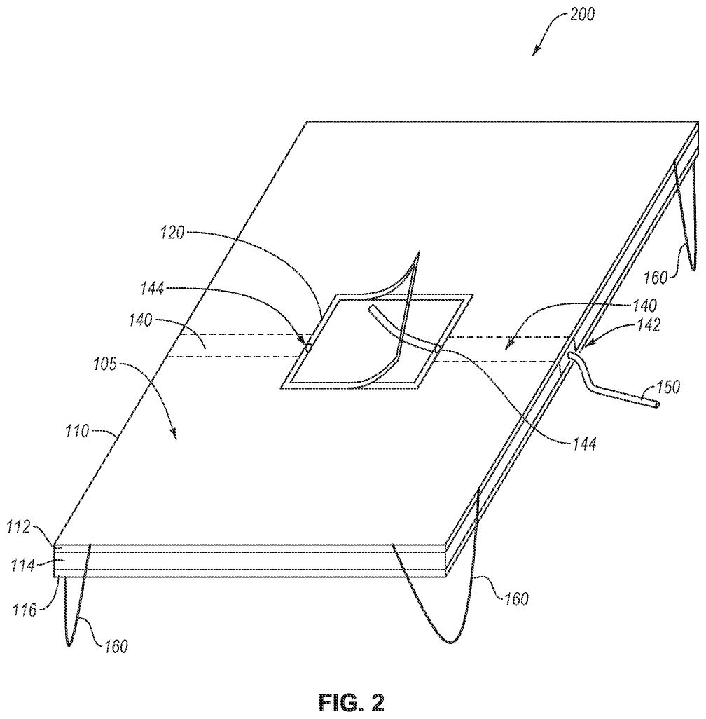

The mattress pad may include tunnels therein to allow a drainage tube to fit therethrough. FIG. 2 is an isometric view of a mattress pad 200 for collecting waste, according to an embodiment. The mattress pad 200 includes the pad 110, the retention port 120 on the pad 110, one or more tunnels 140 in the pad 110, and one or more attachments 130 disposed on the pad 110. The one or more tunnels 140 may be located or formed between layers of the pad 110, such as between the sheet of fabric 112 and one of fluid impermeable sheet 116 or the padding 114. The one or more tunnels 140 may have first openings 142 at the edge of the mattress pad 100 and second openings 144 in or near the retention port 120. Accordingly, drainage tubes 150 may be positioned within the retention port 120 via the tunnels 140 without passing over the upper surface 105 of the mattress pad 200.

The second openings 144 may be located in the retention port 120 or proximate to the retention port 120. The drainage tube 150 may extend out of the tunnel 140 via the second opening 144 such that the drainage tube 150 is not exposed outside of the retention port 120. In some examples, the second opening 144 may be outside of the retention port 120 such that the drainage tube 150 may extend out of the second opening 144 into the retention port 120 and be retained in the retention port 120 via the one or more retainers thereof.

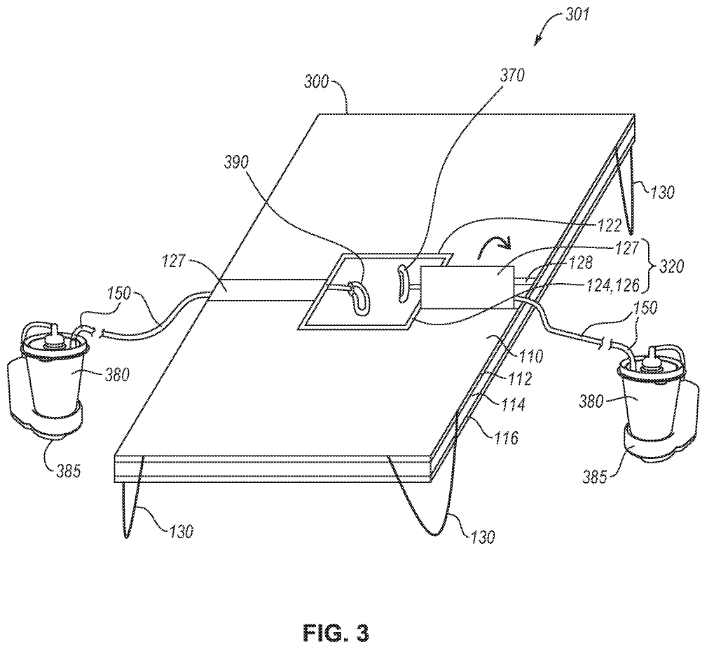

In some examples, the retention port may include openable flaps (e.g., retainers) that extend from a lateral edge of the mattress pad to a central region of the mattress pad. FIG. 3 is a schematic of system 301 for collecting waste, according to an embodiment. The system 301 includes mattress pad 300, at least one fluid storage container 380, at least one vacuum source 385, and optionally, at least one of a fluid collection device 370 or a bodily waste collection device 390. The mattress pad 300 includes retention port 320 with openable flaps 127 for retaining and protecting the drainage tube(s) 150.

The mattress pad 300 includes the pad 110, the retention port 320, and the one or more attachments 130. The pad 110 includes the sheet of fabric 112, the padding 114, and the fluid impermeable sheet 116. The retention port 320 includes one or more of the retainers 122 or openable flaps 127. The flaps 127 may be attached to the pad 110, such as to the sheet of fabric 112. For example, the flaps 127 may hinge from the pad 110. In some examples, the flaps 127 may at least temporarily attach to the pad 110 from one or more sides of the flaps (e.g., one side on a hinge connection or at least two sides with a separate flap that is not permanently affixed to the pad 110). The flaps 127 may extend inward the outer edge of the pad 110 toward the central region of the pad 110, such as to the one or more retainers 122 that at least partially define the retention port 320. The retention port 320 includes fasteners 128 disposed on the pad 110 corresponding to fasteners on the openable flaps 127 to at least temporarily retain the openable flaps 127 in a closed position against the pad 110. For example, the fastener 128 and the corresponding fastener on the openable flaps 127 may include any of the fasteners disclosed herein for the strips 124 and 126, such as hook and loop fasteners, buttons, snaps, or the like. The flaps 127 may be constructed of similar or the same material as the pad 110, such as one or more of the sheet of fabric 112, the padding 114, and the fluid impermeable sheet 116.

In some examples, the pad 110 below the flaps 127 may be thinner than other portions of the pad 110 to accommodate the thickness of the flaps 127, such as to provide a substantially uniform thickness across the pad 110. Such examples, may provide a smoother feel and prevent bedsores compared to examples where the flaps 127 protrude above the pad 110.

During use, the openable flaps 127 may be opened to allow drainage tube 150 to be placed on the underlying pad 110 and then closed (e.g., at least temporarily attached to the pad 110) to retain the drainage tube 150. The drainage tube 150 is secured under the flap 127 and extends from the outer edge of the mattress pad 300 to the central region thereof (e.g., at least to the one or more retainers 122). In some examples, the flaps 127 and the fasteners 128 may be located only adjacent to the central region. In some examples, only one flap 127 and fastener 128 may be used. The one or more retainers 122 may be omitted in some examples.

The at least one of the fluid collection device 370 or the bodily waste collection device 390 may be fluidly connected to the at least one the fluid storage container 380 or the vacuum source 385 via drainage tube(s) 150. For example, the at least one of a bodily waste collection device 390 or fluid collection device 370 are retained relative to the mattress pad 300 by the retention port 320 and fluidly coupled to the at least one fluid storage container 380 and/or vacuum source 385 via the at least one drainage tube 150. The drainage tube(s) 150 may be disposed under and at least partially retained by flaps 127 of the retention port 320 of the mattress pad 300.

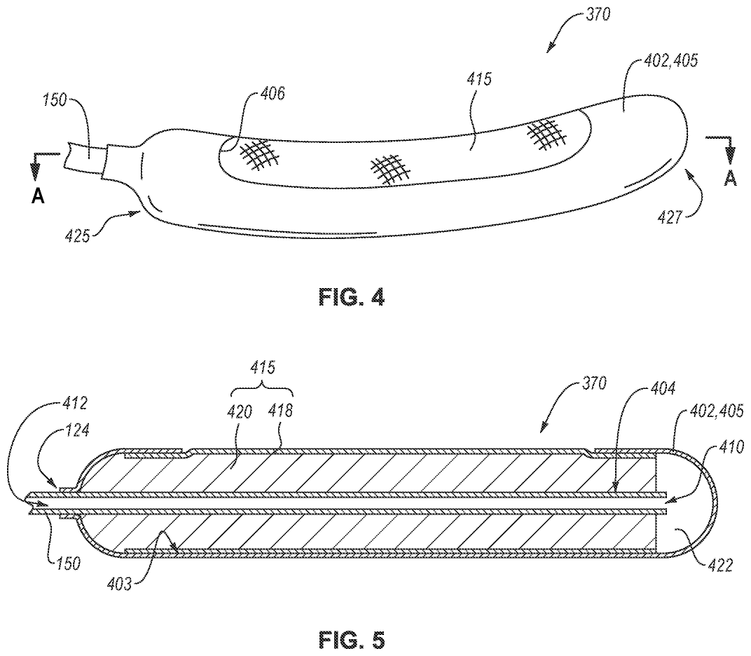

The fluid collection device 370 is sized, shaped, and constructed to collect urine or other fluids from the urethra of the patient. The fluid collection device 370 may prevent or reduce contamination of clothing, bedding, or the patient with bodily fluids. FIG. 4 is an isometric view of a fluid collection device 370, according to an embodiment. FIG. 5 is a cross-sectional view of the fluid collection device 370 of FIG. 4 along the plane A-A. The fluid collection device 370 includes a fluid impermeable barrier 402 defining a chamber 404 therein, porous material 415 at least partially disposed in the chamber 404, and drainage tube 150 at least partially disposed within the chamber 404.

The fluid impermeable barrier 402 at least partially defines the chamber 404 (e.g., interior region) and an opening 406. For example, the inner surface(s) 403 of the fluid impermeable barrier 402 at least partially defines the chamber 404 within the fluid collection device 370. The fluid impermeable barrier 402 at least temporarily retains the fluid(s) in the chamber 404. The fluid impermeable barrier 402 may be formed of any suitable fluid impermeable material(s), such as a fluid impermeable polymer (e.g., silicone, polypropylene, polyethylene, polyethylene terephthalate, thermoplastic elastomer(s), a polycarbonate, etc.), a metal film, natural rubber, another suitable material, or combinations thereof. As such, the fluid impermeable barrier 402 substantially prevents the fluid(s) from passing therethrough.

In an example, the fluid impermeable barrier 402 may be air permeable and liquid impermeable. In such an example, the fluid impermeable barrier 402 may be formed of a hydrophobic material that defines a plurality of pores that are air permeable but not liquid permeable. In an example, one or more portions of at least an outer surface of the fluid impermeable barrier 402 may be formed from a soft and/or smooth material, thereby reducing chaffing.

In some examples, the fluid impermeable barrier 402 may be tubular (ignoring the opening), such as substantially cylindrical (as shown), oblong, prismatic, flattened tube, or any other extruded shape (e.g., a tube having multiple lobes separated by one or more webs therebetween, such as an I-beam shape or the like). The fluid impermeable barrier 402 may be sized to fit between the legs of a wearer. During use, an outer surface 405 of the fluid impermeable barrier 402 may at least partially contact the wearer.

The opening 406 provides an ingress route for fluids to enter the chamber 404. The opening 406 may be defined by the fluid impermeable barrier 402, such as by an inner edge of the fluid impermeable barrier 402. For example, the opening 406 is formed in and extends through the fluid impermeable barrier 402, from the outer surface 405 to the inner surface 403, thereby enabling fluid(s) to enter the chamber 404 from outside of the fluid collection device 370. The opening 406 may be located and shaped to be positioned adjacent to a wearer's urethra while the device is in use. At least a portion of porous material(s) disposed in the chamber 404 may be exposed through the opening 406 to allow fluids to move inwardly into the chamber 404, such as via one or more of permeation, suction, or wicking.

The fluid collection device 370 may be positioned proximate to the urethra and urine may enter the chamber 404 via the opening 406. When in use, the opening 406 may be elongated, extending from a first location below the urethra to a second location above the urethra (e.g., at or near the top of the vaginal opening or the pubic region). The opening 406 may exhibit an elongated shape because the space between the legs of a wearer is relatively narrow when the legs of the wearer are closed, thereby only permitting the flow of the fluid(s) along a path that corresponds to the elongated shape of the opening 406 (e.g., longitudinally extending opening). The opening 406 in the fluid impermeable barrier 402 may exhibit a length that is measured along the longitudinal axis of the fluid collection device 370 that may be at least about 10% of the length of the fluid collection device 370, such as about 25% to about 50%, about 40% to about 60%, about 50% to about 75%, about 65% to about 85%, or about 75% to about 95% of the length of the fluid collection device 370. The opening 406 in the fluid impermeable barrier 402 may exhibit a width that is measured transverse to the longitudinal axis of the fluid collection device 370 and may be at least about 10% of the circumference of the fluid collection device 370, such as about 25% to about 50%, about 40% to about 60%, about 50% to about 75%, about 65% to about 85%, or about 75% to about 100% of the circumference of the fluid collection device 370. The opening 406 may exhibit a width that is greater than 50% of the circumference of the fluid collection device 370 since the vacuum (e.g., suction) through the conduit 408 pulls the fluid through the porous material 415 and into the drainage tube 150. The opening 406 may be longitudinally oriented (e.g., having a major axis parallel to the longitudinal axis of the device 370). In some examples (not shown), the opening 406 may be laterally oriented (e.g., having a major axis perpendicular to the longitudinal axis of the device 370).

The fluid collection device 370 includes the porous material 415 disposed in the chamber 404. The porous material 415 may extend across at least a portion (e.g., all) of the opening 406. At least a portion of the porous material 415 may be exposed to an environment outside of the chamber 404 through the opening 406. The porous material 415 may be configured to wick any fluid away from the opening 406, thereby preventing the fluid from escaping the chamber 404. The permeable properties of the porous material referred to herein may be wicking, capillary action, diffusion, or other similar properties or processes, and are referred to herein as “permeable” and/or “wicking.” Such “wicking” may not include absorption of fluid into the porous material. Put another way, substantially no absorption of fluid into the porous material may take place after the material is exposed to the fluid and removed from the fluid for a time. While no absorption is desired, the term “substantially no absorption” may allow for nominal amounts of absorption of fluid into the porous material (e.g., absorbency), such as less than about 10 wt % of the dry weight of the porous material, less than about 7 wt %, less than about 5 wt %, less than about 3 wt %, less than about 2 wt %, less than about 1 wt %, or less than about 0.5 wt % of the dry weight of the porous material. The porous material 415 may also wick the fluid generally towards an interior of the chamber 404.

The porous material 415 may include one or more of a fluid permeable membrane 418 or a fluid permeable support 420. The fluid permeable membrane 418 may include any porous material or a material that may wick the fluid. For example, the fluid permeable membrane 418 may include fabric, such as a gauze (e.g., a silk, linen, or cotton gauze), another soft fabric, or another smooth fabric. The fluid permeable membrane 418 may include spun plastic fibers (e.g., nylon), such as a spun plastic mat or bed. Forming the fluid permeable membrane 418 from gauze, soft fabric, and/or smooth fabric may reduce chaffing caused by the fluid collection device 370.

The fluid collection device 370 may include the fluid permeable membrane 418 disposed in the chamber 404. The fluid permeable membrane 418 may cover at least a portion (e.g., all) of the opening 406. The fluid permeable membrane 418 may be composed to wick any fluid inwardly away from the opening 406, thereby preventing the fluid from escaping the chamber 404.

The porous material 415 of the fluid collection device 370 may include the fluid permeable support 420 disposed in the chamber 404. The fluid permeable support 420 is composed to support the fluid permeable membrane 418 since the fluid permeable membrane 418 may be formed from a foldable, flimsy, or otherwise easily deformable material. For example, the fluid permeable support 420 may be positioned such that the fluid permeable membrane 418 is disposed between the fluid permeable support 420 and the fluid impermeable barrier 402. As such, the fluid permeable support 420 may support and maintain the position of the fluid permeable membrane 418 thereon. The fluid permeable support 420 may include any material that may wick the fluid, such as any of the fluid permeable membrane materials disclosed herein. For example, the fluid permeable support 420 may be formed from any fluid porous material that is less deformable than the fluid permeable membrane 418, such as any of the materials disclosed herein for the fluid permeable membrane 418, in a more dense or rigid form. In some examples, the fluid permeable support 420 may include a porous polymer (e.g., nylon, polyester, polyurethane, polyethylene, polypropylene, etc.) structure, an open cell foam, or spun plastic fibers (e.g., nylon fibers). In some examples, the fluid permeable membrane 418 may include gauze and the fluid permeable support 420 may include spun nylon fibers. In some examples, the fluid permeable support 420 may be formed from fabric, felt, gauze, or combinations thereof. In some examples, the fluid permeable support 420 may be formed from a natural material, such as cotton, wool, silk, or combinations thereof. In such examples, the material may have a coating to prevent or limit absorption of fluid into the material, such as a water repellent coating. In some examples, the fluid permeable support 420 may be omitted from the fluid collection device 370. In some examples, the fluid permeable membrane 418 may be optional. For example, the porous material 415 may include only the fluid permeable support 420.

The fluid permeable support 420 may have a greater permeability or a greater ability to wick fluids than the fluid permeable membrane 418, such as to move the fluid inwardly from the outer surface of the fluid collection device 370. In some examples, the permeability or the wicking ability of the fluid permeable support 420 and the fluid permeable membrane 418 may be substantially the same.

The fluid permeable membrane 418 and the fluid permeable support 420 may at least substantially completely fill the portions of the chamber 404 that are not occupied by the drainage tube 150. In another example, the fluid permeable membrane 418 and the fluid permeable support 420 may not substantially completely fill the portions of the chamber 404 that are not occupied by the drainage tube 150. In such an example, the fluid collection device 370 includes reservoir 422 in the chamber 404.

The fluid collection device 370 may include the drainage tube 150, which extends into the chamber 404. As illustrated in FIG. 5, the drainage tube 150 may be at least partially disposed in the chamber 404. The drainage tube 150 includes an inlet 410 at a first end region and an outlet 412 at a second end region positioned downstream from the inlet 410. The drainage tube 150 may extend into the chamber 404 to any point therein. For example, the drainage tube 150 may be inserted into the chamber at the first end region 425 of the fluid collection device 370 and extend therethrough to the second end region 427 of the fluid collection device 370. The drainage tube 150 may extend into the fluid impermeable barrier 402 from the first end region 425 (e.g., proximate to the outlet 412) through to the second end region 427 (e.g., opposite the first end region 425) to a point proximate to the reservoir 422 such that the inlet 410 is in fluid communication with the reservoir 422. In some examples (not shown), the drainage tube 150 may enter the chamber 404 in the second end region 427 and the inlet 410 of the drainage tube 150 may be disposed in the second end region 427 (e.g., in the reservoir 422 or flush with fluid impermeable barrier 402). The fluid collected in the reservoir 422 may be removed from the chamber 404 via the drainage tube 150. In some examples, the inlet 410 may be disposed at the end of the fluid permeable support 420 in the second end region 427, such as flush with the end of the fluid permeable support 420. In some examples, the inlet 410 may be disposed within the fluid permeable support 420 such between first end region 425 and the second end region 427.

The drainage tube 150 may include a flexible material such as plastic tubing (e.g., medical tubing). Such plastic tubing may include a thermoplastic elastomer, polyvinyl chloride, ethylene vinyl acetate, polytetrafluoroethylene, etc., tubing. In some examples, the drainage tube 150 may include silicon or latex. In some examples, the drainage tube 150 may include one or more portions that are resilient, such as to by having one or more of a diameter or wall thickness that allows the conduit to be flexible. In some examples, the drainage tube 150 may be frosted or opaque (e.g., black) to obscure visibility of the fluid(s) therein.

The fluid collection device 370 may be operably coupled to the vacuum source 385. For example, the drainage tube 150 fluidly connects an interior region of the chamber 404 with the fluid storage container 380 or the vacuum source 385 (via the fluid storage container 380). Accordingly, fluids may be removed from the chamber 404 via the drainage tube 150.

The fluid impermeable barrier 402, the fluid permeable membrane 418 and the fluid permeable support 420 may be sized and shaped to have the drainage tube 150 at least partially disposed in the chamber 404. For example, at least one of the fluid permeable membrane 418 and the fluid permeable support 420 may be configured to form a space that accommodates the drainage tube 150. The fluid impermeable barrier 402 may define an aperture 424 sized to receive the drainage tube 150. The at least one drainage tube 150 may be disposed in the chamber 404 via the aperture 424. The aperture 424 may be sized and shaped to form an at least substantially fluid tight seal against the drainage tube 150 thereby substantially preventing the fluid(s) from escaping the chamber 404. The fluid collected in the fluid collection device 370 may be removed from the chamber 404 via the drainage tube 150.

The porous material 415 (e.g., fluid permeable membrane 418 and the fluid permeable support 420) may not substantially completely fill the portions of the chamber 404 that are not occupied by the drainage tube 150. The fluid collection device 370 may include the reservoir 422 therein. As shown, the reservoir 422 is a substantially unoccupied portion of the chamber 404. The reservoir 422 may be defined between the fluid impermeable barrier 402 and the porous material 415 (e.g., one or both of the fluid permeable membrane 418 and the fluid permeable support 420). The reservoir 422 may be located in a portion of the fluid collection device expected to (e.g., suitable and intended to) be positioned in a gravimetrically low point of the fluid collection device when worn by a user. While depicted in the second end region 427, the reservoir 422 may be located in any portion of the chamber 404 such as the first end region 425.

In some examples, the fluid permeable support 420 is spaced from at least a portion of the drainage tube 150 and the reservoir 422 may be defined between the fluid permeable support 420 and the drainage tube 150.

As shown in FIG. 5, the end of the drainage tube 150 may extend beyond the fluid permeable membrane 418 and/or fluid permeable support 420, such as into the reservoir 422. In some examples, the inlet 410 may not extend into the reservoir 422. In such examples, the inlet 410 may be disposed within the porous material 415 (fluid permeable membrane 418 and/or fluid permeable support 420) or at a terminal end thereof. For example, an end of the drainage tube 150 may be coextensive with or recessed within the fluid permeable membrane 418 and/or fluid permeable support 420.

Locating the inlet 410 at or near a location expected to be the gravimetrically low point of the chamber 404 when worn by a user enables the drainage tube 150 to receive more of the fluid(s) than if inlet 410 was located elsewhere and reduce the likelihood of pooling (e.g., pooling of the fluid(s) may cause microbe growth and foul odors). For instance, the fluid(s) in the fluid permeable membrane 418 and the fluid permeable support 420 may flow in any direction due to capillary forces. However, the fluid(s) may exhibit a preference to flow in the direction of gravity, especially when at least a portion of the fluid permeable membrane 418 and/or the fluid permeable support 420 is saturated with the fluid(s). Accordingly, one or more of the inlet 410 or the reservoir 422 may be located in the second end region 427.

Other embodiments of fluid impermeable barriers, fluid permeable membranes, fluid permeable supports, chambers, conduits and their shapes and configurations are disclosed in U.S. patent application Ser. No. 15/612,325 filed on Jun. 2, 2017; U.S. patent application Ser. No. 15/260,103 filed on Sep. 8, 2016; and U.S. Pat. No. 10,226,376 filed on Jun. 1, 2017, the disclosure of each of which is incorporated herein, in its entirety, by this reference.

Returning to FIG. 3, a drainage tube 150 may be fluidly connected to the bodily waste collection device 390. The bodily waste collection device 390 is sized, shaped, and constructed to collect bodily waste from the patient, such as liquid or semi-liquid waste (e.g., stool). The bodily waste collection device 390 may prevent or reduce contamination of clothing, bedding, or the patient with bodily waste.

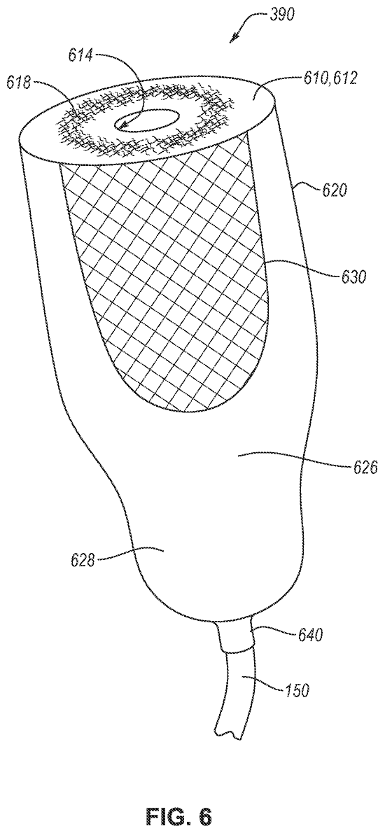

FIG. 6 is an isometric view of bodily waste collection device 390, according to an embodiment. The bodily waste collection device 390 may include an annular body 610, a fluid impermeable barrier 620, an optional filter bag 630, and one or more ports 640. The bodily waste collection device 390 includes an annular body 610, a fluid impermeable barrier 620 forming a waste chamber 626 therein, an optional filter bag 630 disposed within the waste chamber 626, and one or more ports 640 disposed on the fluid impermeable barrier 620. The device 390 is configured to be attached to a wearer to collect the waste from the wearer and remove liquids from the waste. The annular body 610 is attached to the wearer around the wearer's anus or stoma to position the device 390 for use. Waste enters the waste chamber 626 via an opening 614 in the annular body 610, the filter bag 630 in the waste chamber 626 filters the solids from the waste and allows the fluids to pass therethrough, the liquid moves to a gravimetrically low point of the waste chamber 626 and is removed therefrom, such as via vacuum.

The annular body 610 includes a thin interfacing layer 612 having the opening 614 therein. The annular body 610 may be a complete or partial annulus. For example, the annular body 610 may be a disc-shaped body with a hole therein. In some examples, the annular body 610 may include a flat sheet of material with a hole located at or near an edge of the material to form a partial annulus. The interfacing layer 612 is fluid impermeable. For example, the interfacing layer may include a polymer, silicone, or the like. The interfacing layer 612 may be constructed of a smooth and/or soft material such as a closed cell foam, silicon, a smooth plastic, or may include an outwardly facing layer of relatively smooth material and/or soft material (e.g., silicone). The interfacing layer 612 may be deformable responsive to bending forces. For example, the annular body 610 may be compliant for folding, bending, or the like. The interfacing layer 612 may be an annular disc, sheet, plate, or other body having the opening 614 within an outermost periphery thereof. The interfacing layer 612 is sized and shaped to fit at least partially within the intergluteal cleft of a wearer, such as when bent, folded or otherwise manipulated.

The interfacing layer 612 may be deformed to complement the anatomy of a wearer, such as to fit within the intergluteal cleft. The annular body 610 (interfacing layer 612) may be bendable to comply to pressure applied thereto, such as from a wearer or medical professional. The annular body 610 may be composed of a material and have a thickness that allows the annular body 610 to bend responsive to external forces, without breaking.

The annular body 610 (interfacing layer 612) may be foldable to comply to pressure applied thereto, such as from a wearer or medical professional. The annular body 610 may be composed of a material and have a thickness that allows the annular body to fold responsive to external forces, without breaking. For example, a medical professional or a wearer may fold and/or bend the annular body 610 in half to insert the annular body between the buttocks of the wearer to be disposed within the intergluteal cleft during use. Such a fold may form a cusp, having at least a portion of the opening 614 therein. Accordingly, the annular body 610 may be provided as a generally planar body, a bent body, or a folded body. By folding or bending the annular body 610, a wearer or user (e.g., medical professional) may non-intrusively position the opening 614 at least partially around the anus or a stoma of a wearer.

The opening 614 may be disposed within the outer periphery of the interfacing layer 612. As shown, the opening 614 may be disposed at or near a centroid of the interfacing layer 612. The opening 614 may be disposed closer to the outer periphery of the interfacing layer 612 than illustrated. The opening 614 is sized and shaped to fit around (e.g., over) the anus or stoma of the patient without occluding the stoma or anus. For example, the opening 614 may be circular, elliptical, rectangular, or any other shape. Accordingly, the annular body 610 is sized and shaped to be positioned over an anus or stoma of a wearer to position the opening 614 around the anus or stoma. Waste may be passed into the bodily waste collection device 390 via the opening 614.

The interfacing layer 612 of the annular body 610 may include an adhesive 618 thereon to adhere to the skin of a subject, such as within the intergluteal cleft. The adhesive 618 may be integrally formed in or disposed on an outward facing surface of the interfacing layer 612. Such adhesive 618 may secure the bodily waste collection device 390 in position such that the opening 614 is maintained around or at least proximate to the anus or stoma of the wearer. The adhesive 618 may be disposed at one or more points between the opening 614 and the outer periphery of the annular body 610. The adhesive 618 may include a medical adhesive or any other adhesive that is safe to use against the skin of humans, such as acrylate adhesives (e.g., methacrylates, epoxy diacrylates, or cyanoacrylate adhesives), silicone adhesives, hydrogels, or the like.

The fluid impermeable barrier 620 is attached to the annular body 610 to at least temporarily retain received bodily waste therein and prevent leakage to the outside environment. The fluid impermeable barrier 620 includes an open mouth at a first (e.g., upper) end and a closed second (e.g., lower) end. The fluid impermeable barrier 620 is formed from a fluid impermeable material, such as portions (e.g., layers) including a polymer, a metal film, rubber, or the like. For example, the fluid impermeable barrier 620 may include silicone, polypropylenes, polyethylenes, polyethylene terephthalates, polystyrenes, polyurethanes, polycarbonates, polyamides, polyesters, polyacrylates, polychloroprene, vinyl, polyvinyl chloride, poly(vinyl imidazole), latex, silanes (e.g., an halogenated alkyl silane), perfluorinated polymers, polytetrafluoroethylene (PTFE), chlorosulphonate polyolefins, polyethylene oxide, blends or copolymers of any of the foregoing, or any other fluid impermeable polymer.

The fluid impermeable barrier 620 may be transparent in one or more portions thereof. The fluid impermeable barrier 620 may be translucent or opaque in one or more portions thereof. For example, the fluid impermeable barrier 620 may include a transparent window around the filter bag or in a lower portion of the fluid impermeable barrier 620 to allow a user or wearer to monitor waste and liquids therein.

The fluid impermeable barrier 620 includes an outer surface 622 and an inner surface 624. The outer surface 622 may be relatively smooth or soft to prevent sores or discomfort for the wearer. The inner surface 624 defines waste chamber 626. The waste chamber 626 receives and retains the bodily waste therein. Liquid from the bodily waste may travel through the waste chamber 626 from the upper region of the waste chamber 626 to a lower region (e.g., gravimetrically low point) of the waste chamber 626.

The mouth of the fluid impermeable barrier 620 is mated to the annular body 610, such as at the outer periphery of the annular body 610. Accordingly, waste received into the bodily waste collection device 390 enters the waste chamber 626 via the opening 614 of the annular body 610 mated to the fluid impermeable barrier 620. The mouth of the fluid impermeable barrier 620 may be mated to the annular body 610 at the outer periphery thereof, at one or more points internal to the outer periphery such as at the inner periphery of the annular body 610 (e.g., opening 614), or any points between the outer periphery and the opening 614.

The mouth of the fluid impermeable barrier 620 may be adhered, welded, or otherwise affixed to the annular body 610. At least a portion of the fluid impermeable barrier 620 (e.g., mouth of the fluid impermeable barrier 620) may be integrally formed with the annular body 610, such as having a one-piece construction. In such examples, one or more portions of the fluid impermeable barrier may be open as initially formed, and later sealed after the filter bag is installed.

The fluid impermeable barrier 620 may have a substantially cylindrical or conical shape. For example, the fluid impermeable barrier 620 may include an upper portion having a greater outer dimension than a lower portion of the fluid impermeable barrier 620. The fluid impermeable barrier 620 may be shaped as a pouch having opposing sides that are joined along the edges thereof. In some examples, the fluid impermeable barrier 620 may include a sump 628 in a portion of the fluid impermeable barrier 620 intended to be positioned at the gravimetrically low portion of bodily waste collection device 390 during use. The sump 628 may include a portion of the fluid impermeable barrier 620 sized and shaped to direct the fluid in the chamber to one or more ports 640 disposed on the fluid impermeable barrier 620 in the sump 628. For example, the sump 628 may include a narrower portion of the waste chamber 626 than an upper portion. The sump 628 may be a side channel or pocket in the waste chamber 626, a conical shaped terminus of the waste chamber 626, or the like.

The bodily waste collection device 390 optionally includes the filter bag 630 disposed within the waste chamber 626, and positioned to receive waste via the opening 614 of the annular body 610. The filter bag 630 may have a length that is shorter than a length of the fluid impermeable barrier 620. Accordingly, the bottom of the filter bag 630 does not extend to the bottom of the fluid impermeable barrier 620. The filter bag 630 may be substantially cylindrical with a closed bottom substantially opposite to the mouth of the filter bag 630. In some examples, the filter bag is conically shaped. In some examples, the filter bag is configured as or shaped like a pouch. The filter bag filters solid waste from liquid waste in stool which prevents the solid waste from blocking the drainage tube 150 (through which the liquid waste from the stool is removed) attached to the bodily waste collection device 390.

The filter bag 630 may include a bag or pouch constructed of a mesh material. The mesh material has a sieve size selected to allow fluids to pass therethrough and retain solids therein. The sieve size (e.g., mesh size) may include at least about a five micrometer (μm) mesh, such as about 5 μm to about 1,500 μm, about 100 μm to about 1000 μm, about 250 μm to about 500 μm, about 500 μm to about 1,000 μm, less than about 1,500 μm, less than about 400 μm, or larger than about 100 μm. The filter bag 630 may be seamless. The filter bag 630 may include one or more layers of mesh material, such as a single layer or dual layers.

The mesh material may include fibers of a polymer or natural material. For example, the mesh material may include fibers of a polymer, such as nylon, polypropylenes, polyethylenes, polyethylene terephthalates, polystyrenes, polyurethanes, polycarbonates, polyamides, polyesters, polyacrylates, polychloroprene, vinyl, polyvinyl chloride, poly(vinyl imidazole), latex, silanes (e.g., an halogenated alkyl silane), perfluorinated polymers, polytetrafluoroethylene (PTFE), chlorosulphonate polyolefins, polyethylene oxide, blends or copolymers of any of the foregoing. The mesh may be formed of natural fibers such as cotton (e.g., cheesecloth). The mesh material may be woven or non-woven. The mesh material may be a felt of any of the materials disclosed above.

The filter bag 630 may be affixed the annular body 610 or the fluid impermeable barrier 620. For example, the filter bag 630 may be affixed to the annular body 610 between the opening 614 and the outer periphery thereof. The filter bag 630 may be affixed to the underside of the annular body 610 at points between the outer periphery of the annular body 610 and the opening 614. In such examples, the filter bag 630 is spaced from the fluid impermeable barrier 620. By spacing the filter bag 630 from the fluid impermeable barrier 620, a space is created between the filter bag and the fluid impermeable barrier to allow the liquid to separate from the solids in the bodily waste, no matter the orientation of the wearer. A mouth of the filter bag 630 may be bound to the underside of the annular body 610 such that the opening 614 is contained within the filter bag 630. The mouth of the filter bag 630 may be bound to the annular body 610 to encircle the opening 614. Put another way, waste passed into the opening 614 may be disposed within the filter bag 630 first. The mouth of the filter bag 630 may be bound to the underside of the annular body 610 by adhesive (e.g., any adhesive), stitching, heat welding, staples, integral formation, or the like.

The filter bag 630 may be affixed to the annular body 610 at least proximate to the opening 614. The filter bag 630 is affixed to the annular body 610 at the opening 614. For example, the filter bag 630 may be adhered, sewn, stapled, or otherwise attached to the annular body at the opening 614.

The filter bag 630 may be affixed to the annular body 610 at an outer periphery of the annular body 610. In some examples (not shown), the filter bag 630 is affixed to the top of the annular body 610 (e.g., at the outwardly facing portion of the interfacing layer 612), such as by extending out of the waste chamber 626 from the opening 614.

The filter bag 630 includes a mouth at an upper end thereof. In some examples, the mouth of the filter bag 630 may be at least as wide as the mouth of the fluid impermeable barrier 620. Accordingly, the mouth of the filter bag 630 may be affixed to the fluid impermeable barrier 620, such as at the mouth of the fluid impermeable barrier 620. The mouth of the filter bag 630 may be bound to the fluid impermeable barrier 620 by adhesive (e.g., any adhesive), stitching, heat welding, staples, integral formation, or the like.

In some examples, the filter bag 630 may be affixed to the fluid impermeable barrier 620 along the interior surface thereof, such as around the inner diameter of the fluid impermeable barrier at an intermediate point between the mouth and the lowermost extent of the fluid impermeable barrier 620. For example, the filter bag 630 may be spaced from the annular body and mouth of the fluid impermeable barrier 620 by a section of the interior surface of the fluid impermeable barrier 620.

The bodily waste collection device 390 includes the one or more ports 640. The one or more ports 640 provide a passageway to fluidly connect the waste chamber 626 with one or more of the drainage tube 150, a vacuum source, or fluid storage container. The one or more ports 640 are disposed on the fluid impermeable barrier 620. The one or more ports 640 may be positioned in locations at or near where liquid is expected to collect in the waste chamber 626. For example, the one or more ports 640 may be positioned on the fluid impermeable barrier 620 in locations expected to (e.g., suitable and intended to) be at or near a gravimetrically low point of the fluid impermeable barrier 620 during use, such as when a wearer is sitting, laying, reclined, standing, or in any other position. The one or more ports 640 may be positioned in the lower portion of the fluid impermeable barrier 620 at the sump 628. Any number of ports may be used. For example, at least a single port 640 may be disposed in the fluid impermeable barrier 620.

The one or more ports 640 are sized and shaped to connect to drainage tube 150 (or tube) to remove fluids collected in the waste chamber 626. For example, the one or more ports 640 are in fluid communication with the waste chamber 626 and are used to place the drainage tube 150 in fluid communication with the waste chamber 626, such as to remove fluids therefrom. The one or more ports 640 may be sized and shaped to receive the drainage tube 150 therein, such as being a female connection. The female connection may be sized and shaped to allow the drainage tube 150 to insert therein. The one or more ports 640 may be configured to receive the drainage tube 150 thereon, such as being a male connection (e.g., nipple or tube connection). When the drainage tube 150 is connected to the one or more ports 640, the drainage tube 150 fluidly couples the chamber 626 to one or more of the fluid storage container 380 or vacuum source via the one or more ports 640.

The fluids (e.g., liquid from bodily waste) may be removed from the waste chamber of the bodily waste collection device 390 via the drainage tube 150. The fluid may travel through the drainage tube 150 to the fluid storage container 380, such as via vacuum force or gravity. The drainage tube 150 from multiple ports 640 may be joined into single piece of drainage tube 150 via a manifold (not shown). The manifold may include male or female connections for mating to the drainage tube 150.

Suitable examples of bodily waste collection devices 390 are disclosed in PCT International Patent Application No. PCT/US2021/035181, filed 1 Jun. 2021, the disclosure of which is incorporated herein, in its entirety, by this reference. Further examples of bodily waste collection devices may be used with the devices, systems, and methods disclosed herein, such as ostomy bags, vomit bags, or the like. Such devices may be fluidly coupled to drainage tube 150 to remove at least some of the collected bodily waste therefrom.

Returning again to FIG. 3, the at least one of a bodily waste collection device or a fluid collection device are retained relative to the mattress pad 300 by the retention port and fluidly coupled to the at least one fluid storage container 380 via the at least one drainage tube 150. While the system 301 is illustrated with a specific fluid collection device 370 and bodily waste collection device 390, such devices are merely examples. The system 301 or any of the mattress pads disclosed herein may be used with any commerically avaible urine or stool collection devices.

Fluid storage container 380 may include a bag (e.g., drainage bag), a rigid bottle or cup (e.g., collection jar), or any other enclosed container for storing bodily fluids. The fluid storage container(s) 380 may be fluidly connected to the vacuum source(s) 385, such as via a portion of drainage tube 150. The vacuum source(s) 385 may provide a vacuum for pulling fluids from one or more of the fluid collection device 370 or the bodily waste collection device 390 into the fluid storage container(s) 380 via the at least one drainage tube 150. The fluid collected in the one or more of the fluid collection device 370 or the bodily waste collection device 390 is moved through the drainage tube 150 into the fluid storage container 380. By having a separate connection to the vacuum source 385 on the fluid storage container 380, the fluids removed from the fluid collection device 370 or the bodily waste collection device 390 may be prevented from entering the vacuum source 385.

The vacuum source 385 may include one or more of a manual vacuum pump, an electric vacuum pump, a diaphragm pump, a centrifugal pump, a displacement pump, a magnetically driven pump, a peristaltic pump, or any pump configured to produce a vacuum. The vacuum source 385 may include a wall mounted suction line, such as found in a hospital room. In examples, the vacuum source 385 may be powered by one or more of a power cord (e.g., connected to a power socket), one or more batteries, or even manual power (e.g., a hand operated vacuum pump). The vacuum source 385 may include one or more of a switch, a button, a plug, a remote, or any other actuator suitable to activate the vacuum source 385. The vacuum source 385 may be selectively operated by a user (e.g., medical personnel, the wearer, or a caretaker).

Any mattress pad or component thereof disclosed herein may be used in the system 301. For example, some mattress pads may have more padding than other mattress pads.

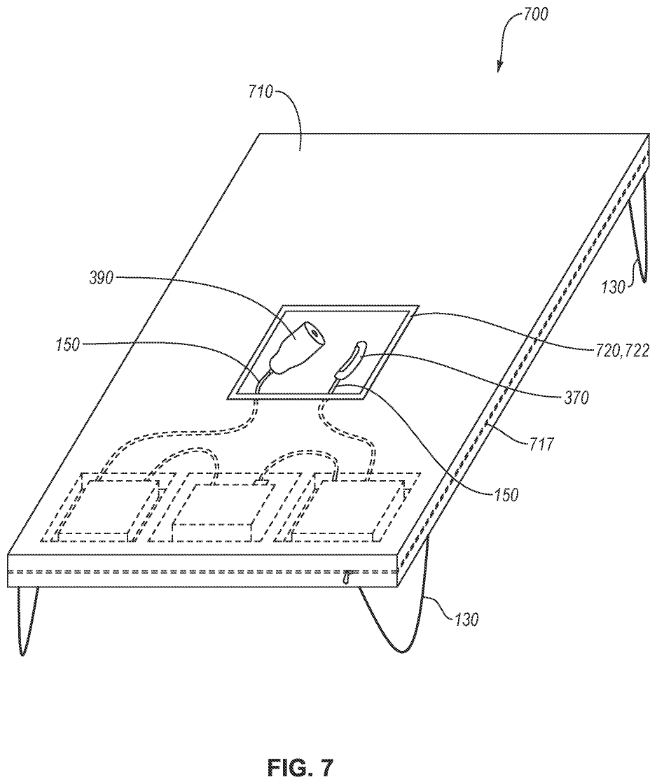

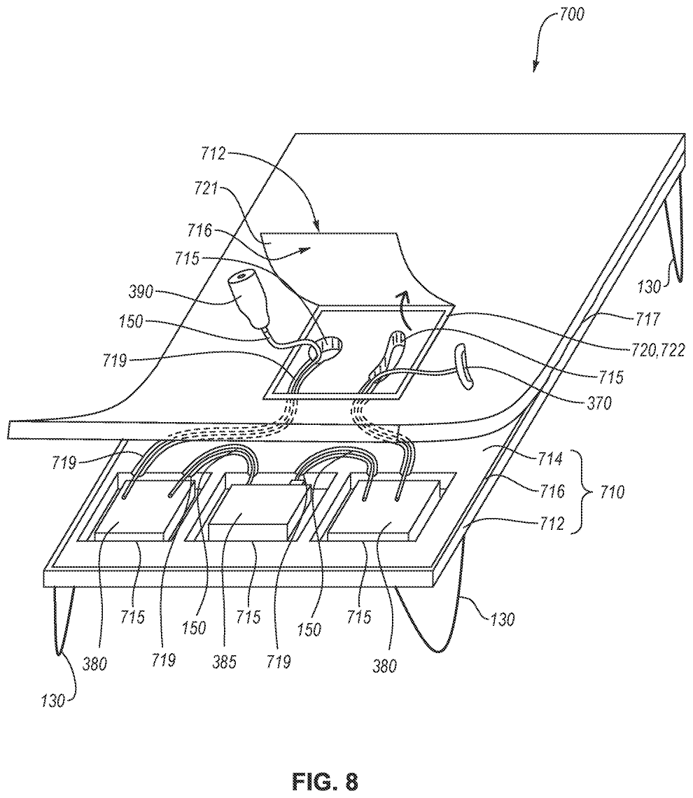

FIG. 7 is an isometric view of a system 701 for collecting waste, according to an embodiment. FIG. 8 is an isometric view of the system 701 for collecting waste with a partially open cover, according to an embodiment. The system 701 includes mattress pad 300, at least one fluid storage container 380, at least one vacuum source 385, and at least one of a fluid collection device 370 or a bodily waste collection device 390. The mattress pad 700 includes an openable retention port 720 for storing, retaining, and protecting the drainage tube(s) 150 and the at least one of the fluid collection device 370 or the bodily waste collection device 390 at least partially inside of the mattress pad 700. The mattress pad 700 includes one or more recesses 715 formed therein for housing the fluid collection device 370, the bodily waste collection device 390, the at least one vacuum source 385 (e.g., vacuum pump), at least one fluid storage container 380, and drainage tubes 150 fluidly connecting any of the foregoing.

The mattress pad 700 includes the pad 710. The pad 710 includes the cover 712 and body of padding material 714 disposed within the cover 712. The pad 710 has a thickness which at least partially accommodates one or more of the fluid collection device 370, the bodily waste collection device 390, the at least one vacuum source 385, at least one fluid storage container 380, or drainage tubes 150 fluidly connecting any of the foregoing therein.

The cover 712 may be similar or identical to the sheet of fabric 112 in one or more aspects. For example, the cover 712 may include a fabric having fibers made of one or more of cotton, polymer (e.g., polyester), satin, silk, linen, or combinations thereof (e.g., poly-cotton). The fabric of the cover 712 may be on an uppermost face of the pad 710, such as a patient facing side of the pad 710. The cover 712 may be sized and shaped to at least partially cover the body of padding 714, such as to encapsulate the body of padding 714. The cover 712 includes a resealable fabric container for holding the body of padding material. For example, the cover 712 may include a zipper 717 or another selectively closable fastener for closing the cover 712 over the body of padding 714. The zipper 717 may extend around at least a portion of the side of the mattress pad 700 to allow access to one or more portions of the mattress pad 700 within the cover 712.

As shown in FIG. 7, the mattress pad 700 may be thicker than the mattress pads (e.g., toppers) 100, 200, or 300, due at least in part to the thickness of the body of padding material 714. The body of padding 714 may be similar or identical to the padding 114 in one or more aspects, such as composition, dimensions, or the like. For example, the body of padding material 714 may include cotton fibers, wool fibers, spun plastic fibers (e.g., polyester), down, polymer foam, or the like. The body of padding material 714 may be provided as a solid body, filler (e.g., pieces), or panels. The body of padding material 714 may be at least 4 cm thick (when in an uncompressed state), such as 4 cm to 15 cm, 4 cm to 8 cm, 8 cm to 12 cm, 12 cm to 15 cm, less than 15 cm, less than 10 cm, or more than 10 cm. The body of padding material 714 may be more compressible near the outermost surfaces thereof, such as nearest the upper surface. Accordingly, the body of padding material 714 may provide comfort to a patient thereon and prevent or decrease a patient's ability to feel the components disposed within the pad 710.

The body of padding material 714 includes one or more recesses 715 formed therein for holding components therein. At least some of the one or more recesses 715 may be sized and shaped to hold fluid collection device 370 or a bodily waste collection device 390, fluid storage container 380 (e.g., urine storage container, stool storage container, etc.), or vacuum source 385 therein. For example, one or more recesses 715 may be disposed in the central region, such in (e.g., below) the retention port 720, for accommodating the fluid collection device 370 and the bodily waste collection device 390 within the pad 710. One or more recesses 715 may be disposed in a region of the body of padding material 714 expected to (e.g., suitable and intended to) be positioned near a foot end of a mattress (upon which the mattress pad 700 sits) when in use. For example, one or more recesses 715 may be disposed in the foot end region for accommodating one or more of fluid storage container 380 (e.g., urine storage container, stool storage container, etc.) or vacuum source 385 therein. By locating the recesses 715 in the foot end region, the contents therein may not cause discomfort to the patient when the patient lays on the mattress pad 700 due to the relatively light weight of the feet and legs not compressing the mattress pad 700 as much as a torso. In some examples, the one or more recesses 715 for accommodating one or more of fluid collection device 370, bodily waste collection device 390 fluid storage container 380, or vacuum source 385 (e.g., vacuum pump) therein may be positioned anywhere within the pad 710, such as around the periphery of the mattress pad 700, at the head of the mattress pad 700, or the like.

At least some of the one or more recesses 715 may be connected via a connecting recess 719 sized and shaped to accommodate drainage tube 150 therein. The connecting recesses 719 may be disposed between any of the recesses 715. In some examples, the connecting recesses 719 may be configured as tunnels in the body of padding 714. At least some of the one or more recesses 715 and connecting recesses 719 are accessible by opening the cover 712. For example, the cover 712 may be unzipped and opened to expose the one or more recesses 715, one or more connecting recesses 719, and contents thereof. In such examples, the contents of the fluid storage container(s) 380 (e.g., urine and bodily waste) are hidden from view to prevent embarrassment to the patient and visitors.

The body of padding material 714 may include two or more parts, such as an upper body and a lower body as shown in FIG. 8. The one or more recesses 715 and connecting recesses 719 may be formed in the upper body and the lower body of padding. In some examples, the one or more recesses 715 and connecting recesses 719 are formed only in the lower body of padding and the upper body of padding may be disposed thereover. Upon opening the cover 712, the upper and lower bodies may be separated to view or change the contents of the one or more recesses 715 and connecting recesses 719. For example, the fluid storage containers 380 may be changed or checked by opening the cover 712.

The pad 710 may include a fluid impermeable sheet 716 within or on the cover 712. For example, the pad 710 may include the fluid impermeable sheet 716 disposed between the cover 712 and the body of padding material 714, such as at least on the upper (e.g., patient-facing) surface thereof. In some examples, the cover 712 may include the fluid impermeable sheet 716 disposed across at least the retention port 720. The fluid impermeable sheet 716 may be similar or identical to the fluid impermeable sheet 116 or 160 in one or more aspects.

Retention port 720 is disposed on the cover 712, such as in the central region of the cover 712. The retention port 720 may be similar or identical to the retention port 120 or 320 in one or more aspects. The retention port 720 includes one or more retainers 722 disposed around (and at least partially defining) an outer boundary thereof. The one or more retainers 722 are similar or identical to the one or more retainers 122 in one or more aspects. For example, the one or more retainers 722 may include first and second strips with fasteners as disclosed herein with respect to retainers 122.

The retention port 720 may include an openable portion 721. The openable portion 721 may include a portion of the cover 712, such as the portion of the cover 712 within the retention port 720. For example, the fluid impermeable sheet 716 may be removable to access the body of padding material 714 therein. The retention port 720 includes a fluid impermeable sheet 716 attached to the cover 712 in a middle region or portion (e.g., central region) thereof. For example, the openable portion 721 may include fluid impermeable sheet 716 for a lower surface and the cover 712 for the upper surface. As shown in FIG. 7, the openable portion 721 may be retained against the body of padding material 714 by the one or more retainers 722 or by one or more retainers specific to the openable portion 721. As shown in FIG. 8, the openable portion 721 may be lifted to expose the body of padding material 714 therebelow. The openable portion 721 may be closed by attaching the cover 712 and/or fluid impermeable sheet 716 with the one or more retainers 722 or one or more retainers specific to the openable portion 721. The cover 712 may include one or more openings such as in the retention port 720 to allow the drainage tubes 150 to pass therethrough when in use.

The components depicted in FIGS. 7 and 8 also represent a bodily waste collection system. Bodily waste collection systems may be utilized to collect fluids and bodily waste from patients in a bed, such as a hospital bed.

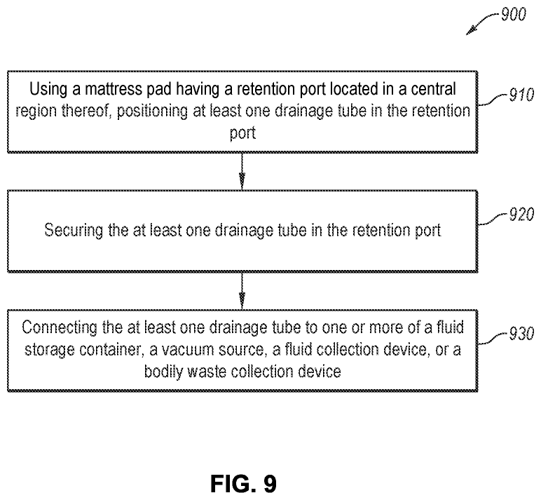

FIG. 9 is a flow diagram of a method 900 to collect bodily waste, according to an embodiment. The method 900 includes block 910, which recites “using a mattress pad having a retention port located in a central region thereof, positioning at least one drainage tube in the retention port.” Block 910 may be followed by block 920, which recites “securing the at least one drainage tube in the retention port.” Block 920 may be followed by block 930, which recites “connecting the at least one drainage tube to one or more of a fluid storage container; a vacuum source; a fluid collection device, or a bodily waste collection device.” Blocks 910, 920, 930 of the method 900 are for illustrative purposes. For example, the blocks may be modified, supplemented, split, or combined. In an example, one or more of the blocks 910, 920, 930 of the method 900 may be omitted from the method 900. Any of the blocks 910, 920, or 930 may include using any of the mattress pads disclosed herein.

Block 910 recites “using a mattress pad having a retention port located in a central region thereof, positioning at least one drainage tube in the retention port.” The mattress pad may include any of the mattress pads disclosed herein, including any of the components thereof. The retention port may include any of the retention portions disclosed herein, including any of the components thereof. For example, the retention port may include any of the retainers, flaps, or the like disclosed herein. The retention port may include one or more retainers disposed around an outer boundary thereof, the one or more retainers being configured to hold one or more objects relative to the retention port. The one or more retainers may include hook and loop fasteners and positioning the at least one drainage tube in the retention port may include positioning a portion of the at least one drainage tube between the hook and loop fasteners, such as between first and second strips having the hook and loop fasteners (or other fasteners) thereon.

The retention port may include one or more flaps as disclosed herein and positioning at least one drainage tube in the retention port may include positioning the drainage tube below one or more flaps. The drainage tube may extend from a side of the mattress pad under the one or more flaps to the central region of the mattress pad.

In some examples, the mattress pad may include a cover and a body of padding material disposed within the cover, the body of padding material includes one or more recesses formed therein for holding components therein. At least some of the one or more recesses are sized and shaped to hold one or more of a fluid storage container, a vacuum pump, a stool storage container, a fluid collection device, or a bodily waste collection device. The retention port may be disposed on the cover. In such examples, positioning the at least one drainage tube in the retention port may include pulling a portion of the at least one drainage tube through the one or more recesses. For example, the at least one drainage tube may be pulled from recesses inside of the mattress pad to extend outside thereof for use in collecting fluids from a patient on the mattress pad. In some examples, the method 900 may include removing one or more of a fluid collection device, a bodily waste collection device, a fluid storage container (e.g., urine storage container or stool storage container), a vacuum pump, from the mattress pad or one or more recesses therein.

Block 920 recites “securing the at least one drainage tube in the retention port.” Securing the at least one drainage tube in the retention port may include closing the first and second strips over the drainage tube(s) therebetween. For example, hook and loop fasteners on the first and second strips may be closed on each other the bond the hooks to the loops to secure the drainage tube(s) therebetween in position relative to the retention port. In some examples, securing the at least one drainage tube in the retention port may include closing the flaps in the retention port over the drainage tube(s). The flaps may be secured to the pad via fasteners (e.g., hook and loop fasteners). Accordingly, securing the at least one drainage tube in the retention port may include attaching the fasteners of the flaps and/or first and second strips.

Block 930 recites, “connecting the at least one drainage tube to one or more of a fluid storage container; a vacuum source; a fluid collection device, or a bodily waste collection device.” Connecting the at least one drainage tube to one or more of a fluid storage container; a vacuum source; a fluid collection device, or a bodily waste collection device may include fluidly connecting the fluid storage containers to one or more of the vacuum source, the fluid collection device, or bodily waste collection device. The drainage tubes may be fluidly connected to fluid storage containers, vacuum sources, fluid collection devices, or bodily waste collection devices prior to, contemporaneous with, or after positioning the drainage tube within the retention port.

The method 900 may include positioning the mattress pad on a mattress. Positioning the mattress pad on a mattress may include securing the mattress pad to the mattress such as using the attachments (e.g., sheet straps, clips, or the like).

The method 900 may include placing one or more sanitary (bed) pads in the retention port. The sanitary pads may include chucks or the like. The sanitary pads may be secured in the retention port, such as via the one or more retainers.

The method 900 may include positioning the opening of the fluid collection device over the urethra of the patient. Accordingly, fluid passed through the urethra of the wearer may be captured in the fluid collection device.

The method 900 may include positioning the opening of the bodily waste collection device over the anus or stoma of the patient. Accordingly, bodily waste passed through the anus or stoma may pass through the opening into the bodily waste collection device. Positioning the opening of the bodily waste collection device over the anus or stoma of a wearer may include adhering the annular body to the wearer, such as in the intergluteal cleft of the wearer.

The method 900 may include receiving one or more of bodily fluid or bodily waste in the fluid collection device or bodily waste collection device. The method 900 may include removing the fluid from one or more of the fluid collection device or the bodily waste collection device. Removing the fluid may include removing the fluid via the one or more ports and drainage tubing or tube, such as via gravity or vacuum. The vacuum may be selectively applied using the vacuum source to remove the fluid(s) therefrom. For example, the patient or a user (e.g., medical professional) may activate the vacuum source to remove the liquid(s).

In some examples, the method 900 may include collecting the fluid(s) that are removed from the one or more of the fluid collection device or bodily waste collection device, such as into a fluid storage container(s) fluidly connected thereto. The fluid storage container may include any of the fluid storage containers disclosed herein. The collected fluid may be quantified or analyzed.

In some examples, the method 900 may include changing the fluid collection device for a new fluid collection device or bodily waste collection device for a new bodily waste collection device, such as when the filter bag fills up. In some examples, the method 900 may include changing the fluid collection container(s) for new fluid collection container(s), such as when the fluid storage containers fill up.

The mattress pads disclosed herein allow medical professionals to manage tubing for bodily waste and fluid collection devices, allow retention of the bodily waste and fluid collection devices with respect to the mattress pad, provide for patient comfort by preventing the patient from laying on the drainage tubes, and prevents soiling of the mattress and/or bedding underneath the mattress pad.

While various aspects and embodiments have been disclosed herein, other aspects and embodiments are contemplated. The various aspects and embodiment disclosed herein are for purposes of illustration and are not intended to be limiting. Features from any of the disclosed embodiments may be used in combination with one another, without limitation.

What is claimed is:

1. A mattress pad for collecting waste, the mattress pad comprising:
a pad sized and shaped to cover at least a portion of a mattress;
a retention port located in a region of the pad, the retention port including one or more retainers disposed around an outer boundary thereof, the one or more retainers being configured to hold one or more objects relative to the retention port; and
one or more attachments disposed on the pad, the one or more attachments being configured to at least temporarily attach the pad to the mattress.

2. The mattress pad of claim 1 wherein the pad includes a sheet of fabric on an uppermost face thereof.

3. The mattress pad of any of claim 2 wherein the pad includes padding disposed below the sheet of fabric.

4. The mattress pad of any of claims 1-3 wherein the pad includes a fluid impermeable sheet.

5. The mattress pad of claim 4 wherein the fluid impermeable sheet extends across at least the retention port.

6. The mattress pad of any of claims 1-5 wherein the one or more retainers of the retention port include hook and loop fasteners disposed around at least a portion of the outer boundary of the retention port.

7. The mattress pad of claim 6 wherein the hook and loop fasteners include a first portion having hook fasteners disposed on the mattress pad around the outer boundary of the retention port and a second portion having loop fasteners disposed on a boundary strip corresponding to a shape of the first portion of the hook and loop fasteners to at least partially define the outer boundary, wherein the second portion is removable from the first portion.

8. The mattress pad of any of claims 1-7 wherein the one or more retainers of the retention port include one or more of buttons, snaps, a zipper, or magnets disposed around at least a portion of the outer boundary of the retention port.

9. The mattress pad of any of claims 1-8 wherein the retention port is located on a central region of the mattress pad expected to hold a pelvic region of a patient thereon.

10. The mattress pad of any of claims 1-9 wherein one or more of the pad or the retention port includes one or more openings therein sized and shaped to accommodate a drainage tube therethrough.

11. The mattress pad of any of claims 1-10 wherein the pad includes a cover and a body of padding material disposed within the cover.

12. The mattress pad of claim 11 wherein the cover includes a resealable container for holding the body of padding material.

13. The mattress pad of any of claims 11-12 wherein the retention port is disposed on the cover.

14. The mattress pad of any of claims 11-13 wherein the cover includes a fluid impermeable sheet disposed across at least the retention port.

15. The mattress pad of any of claims 11-14 wherein the body of padding material includes one or more recesses formed therein for holding components therein.

16. The mattress pad of claim 15 wherein at least some of the one or more recesses are disposed below the retention port.

17. The mattress pad of any of claims 15-16 wherein at least some of the one or more recesses are sized and shaped to hold a fluid collection device or a bodily waste collection device therein.

18. The mattress pad of any of claims 15-17 wherein the at least some of the one or more recesses are disposed in a region of the body of padding material suitable and intended to be positioned near a foot end of a mattress when in use.

19. The mattress pad of claim 18 wherein the one or more recesses are sized and shaped to hold one or more of a fluid storage container, a vacuum pump, or a stool storage container.

20. The mattress pad of claim 19 wherein at least some of the one or more recesses are connected via a connecting recess sized and shaped to accommodate a drainage tube therein.

21. The mattress pad of any of claims 11-20 wherein the at least some of the one or more recesses are accessible by opening the cover.

22. The mattress pad of any of claims 11-21 wherein the retention port includes a fluid impermeable sheet attached to the cover in a central region thereof.

23. The mattress pad of claim 22 wherein the fluid impermeable sheet is removable to access the body of padding material therebelow.

24. A bodily waste collection system, the system comprising:
a mattress pad according any of claims 1-23;
at least one fluid storage container configured to hold a fluid;
at least one of a bodily waste collection device or a fluid collection device retained relative to the mattress pad by the retention port and fluidly coupled to the at least one fluid storage container via at least one drainage tube; and
a vacuum source fluidly coupled to one or more of the at least one of the fluid storage container or the at least one bodily waste collection device via the at least one drainage tube, the vacuum source configured to draw fluid into the at least one fluid storage container from the at least one of a bodily waste collection device or a fluid collection device via the at least one drainage tube.

25. The bodily waste collection system of claim 24 wherein the fluid collection device includes:
a fluid impermeable barrier having an outer surface and an inner surface, the inner surface at least partially defining a chamber, the fluid impermeable barrier also defining an opening extending therethrough, the opening configured to be positioned adjacent to a urethra;
a porous material at least partially disposed in the chamber; and
the at least one drainage tube is fluidly connected to the chamber.

26. The bodily waste collection system of claim 25 wherein the porous material includes a fluid permeable support and a fluid permeable membrane disposed over at least a portion of the fluid permeable support.

27. The bodily waste collection system of any of claims 24-26 wherein the at least one bodily waste collection device includes:
an annular body defining an opening therein, the annular body being configured to be positioned over an anus or a stoma of a wearer to position the opening around the anus or the stoma;
a fluid impermeable barrier affixed to the annular body, the fluid impermeable barrier having an outer surface and an inner surface, the inner surface at least partially defining a waste chamber within the fluid impermeable barrier; and
the at least one drainage tube is fluidly connected to the waste chamber.

28. The bodily waste collection system of claim 27 wherein the bodily waste collection device includes one or more ports disposed on the fluid impermeable barrier and the one or more ports are attached to the at least one drainage tube.

29. The bodily waste collection system of any of claims 24-28 wherein the one or more of at least one of a bodily waste collection device or a fluid collection device are retained relative to the mattress pad via the at least one drainage tube being retained within the retention port.

30. A method for utilizing a mattress pad, the method comprising:
using a mattress pad having a retention port located in a region thereof, positioning at least one drainage tube in the retention port;
securing the at least one drainage tube in the retention port; and
connecting the at least one drainage tube to one or more of a fluid storage container, a vacuum source, a fluid collection device, or a bodily waste collection device.

31. The method of claim 30 wherein the retention port includes one or more retainers disposed around an outer boundary thereof, the one or more retainers being configured to hold one or more objects relative to the retention port.

32. The method of claim 31 wherein:
the one or more retainers include hook and loop fasteners; and
positioning the at least one drainage tube in the retention port includes positioning a portion of the at least one drainage tube between the hook and loop fasteners.

33. The method of any of claims 30-32 wherein:
the mattress pad includes a cover and a body of padding material disposed within the cover, the body of padding material includes one or more recesses formed therein for holding components therein;
the retention port is disposed on the cover; and
positioning the at least one drainage tube in the retention port includes pulling a portion of the at least one drainage tube through the one or more recesses.

34. The method of claim 33 wherein at least some of the one or more recesses are sized and shaped to hold one or more of a fluid storage container, a vacuum pump, a stool storage container, a fluid collection device, or a bodily waste collection device.

35. The method of claim 34, further comprising removing one or more of a fluid collection device or a bodily waste collection device from the one or more recesses.

36. The method of claim any of claims 34-35, further comprising removing one or more of a fluid storage container, a vacuum pump, or a stool storage container from the mattress pad.

37. The method of any of claims 30-35, further comprising positioning the mattress pad on a mattress.

38. The method of any of claims 30-36, further comprising placing one or more sanitary pads in the retention port.

39. The method of any of claims 30-37, further comprising receiving one or more of bodily fluid or bodily waste in the fluid collection device or bodily waste collection device.

40. The method of any of claims 30-37, further comprising applying suction with the vacuum source to one or more of the fluid collection device or bodily waste collection device to remove one or more of bodily fluid or bodily waste therefrom.
